(19) United States
(12) Patent Application Publication
(10) Pub. No.: US 2004/0016131 A1
(43) Pub. Date: Jan. 29, 2004

(54) Assistant tool for cutting vegetables

(76) Inventor: Toshio Hayashi, Tokyo (JP)

Correspondence Address: Norris, McLaughlin & Marcus P.A., 30th Floor, 220 East 42nd Street, New York, NY, 10017, US

(21) Appl. No.: 10/623,245

(22) Filed: Jul. 18, 2003

(30) Foreign Application Priority Data
Jul. 22, 2002 (JP) 2002-212263
Jul. 16, 2003 (JP) 2003-275059

(51) Int. Cl. B26B 3/00; A23L 1/00

(52) U.S. Cl. 30/302

(57) ABSTRACT

An assistant cutting tool for cutting vegetables, such as onions, the tool having a body with a semi-spherical inner space and a plurality of slits within the body so as to be traversed over the body to connect the inner space and the outside. A half cut onion is held in the inner surface and is cut by inserting a blade of a knife through the slits successively. After the onion is cut in one direction, it is then rotated by 90 degrees and then cut again in the same manner to obtain small pieces of onion. According to the tool, small dice-like onion pieces can be obtained.

### BACKGROUND OF THE INVENTION

1) Field of the Invention

The present invention relates to an assistant cutting tool, and particularly, relates to a cutting tool for cutting spherical shaped vegetables, such as onions, into small pieces.

2) Related Art Statements

In order to cut vegetables such as an onion into small pieces, it is necessary to put a knife finely in cross directions, and the operation to put a knife requires a great skill.

When cutting onions in small pieces, a cook generally cuts an onion into half first, and then cuts one of the half cut onions in two directions crossing each other. That is to say, the onion is cut in one direction to make slices, then the direction is changed by 90 degrees and cutting the onion in another direction to make it into small pieces. In order to cut the onion into sufficiently smaller pieces, the onion may be sliced in a horizontal direction before cutting the onion in vertical cross directions.

However, according to the conventional cutting method, as the onion is progressively cut, the shape of the onion becomes unstable to hold, because the uncut onion becomes smaller and smaller. Further, since onions consist of scale-like pieces stacked together, when the cutting operation progresses to a half or more of the onion, it becomes difficult to put a knife straight against the rest of the onion. Furthermore, there are problems such that the pieces of onion are left piece by piece on the cutting board, such that the cook sheds tears due to the nature of onion.

In order to solve these problems, an onion assistant cutting tool is suggested in Japanese Utility Model Registration No. 3056612. This onion assistant cutting tool comprises a square base plate having teeth-like stems sitting around the base plate being extended in an upper direction. A cook inserts a knife successively in the spaces between the stems in order to cut the onion in small pieces. The tool further comprises a safety cover, which is for protecting the fingers of the cook when using a knife to cut onions.

However, in the conventional tool for cutting onions, it is not easy to insert the knife in a correct position, i.e. in the spaces between the stems facing to each other. That is to say, this tool is so designed that the cook selects the position for inserting a knife between the proximal side stem and the opposite one with his or her eyes; however, it is not easy to find correctly the corresponding stems, since the stems are provided very closely to each other. Therefore, a knife cannot be put in the correct position, and then the onions are cut perspective so that the size of the pieces becomes uneven.

Further, the safety cover is so designed to be supported by the stems. However, when cutting an end of the onion, the safety cover cannot be supported by the stems.

Furthermore, since the top portion of the conventional tool is open, the above-mentioned problems cannot be solved so that the cut pieces of the onion are left piece by piece and the cook sheds tears because of the cut onion. In addition, according to the conventional tool, it is impossible to cut onions in a horizontal direction.

### SUMMARY OF THE INVENTION

The present invention has for its purpose to provide an assistant cutting tool for cutting vegetables such as onions into small pieces. By using the tool, an operator can cut onions into small pieces of the same size without requiring any special skill.

In order to carry out the purpose, the assistant cutting tool according to the invention comprises a covering body having an inner space with a flat opening end surface in which an object to be cut is able to be held, and a plurality of slits being provided within the body through which said inner space and an outer space are connected.

According to this construction, the object to be cut is put on a flat portion, for instance, on a cutting board, covered with the body being held in the inner space, and inserting a knife through the slits to cut the object into sliced pieces. Since the object cut is being covered with the body, it is prevented that the tear causing nature of the onion occurs. It should be noted that the invention can be applied to cut many different kinds of vegetables by modifying the shape of the inner space of the body so as to meet the outer shape of the vegetables to be cut.

It is preferred to provide the slits so as to be traversed all over the body and to be parallel to each other in a direction (first direction) which is perpendicular to the flat opening end surface of the inner space. It is further preferred that the slits are provided with even distances.

According to this construction, it becomes possible to cut the object to be cut with the same size.

The assistant cutting tool according to the invention has an aspect that said inner space has a semi-spherical shape and each of said slits is extended to the portion in the vicinity of the opening end of the inner space.

Such an assistant cutting tool can be preferably used to cut vegetables having a spherical shape, such as onions, into small pieces. That is to say, the vegetable having a spherical shape is cut into half and put on a flat portion facing the cut surface on the lower side, then cover the onion with the body of the tool so as to hold the vegetable inside of the inner space, and then cut the vegetable by inserting a knife through the slits. As stated above, sliced pieces of the vegetable can be obtained by cutting it in one direction. Then, by rotating the body (or the vegetable) by 90 degrees and cutting the vegetable again in another direction, which crosses to the first direction; thereby a fine cut vegetable can be obtained. Since the vegetable is cut in a condition that it is covered with the body, the vegetable can be cut without being left piece by piece. In addition, it can be prevented that the tear causing composition of the vegetable occurs.

The assistant cutting tool according to the invention has another aspect that the inner space has a semi-spherical shape arid the plurality of slits are provided being parallel to the opening end surface of the inner space and cut out from one side of the body in the same direction, and the slits are extended at least to a portion in the vicinity of the surface which forms the inner space at another side that is opposite to said one side.

The assistant cutting tool having this construction is preferably used for cutting an object to be cut in a horizontal direction. As stated above, the vegetables, such as onions, may be cut in a horizontal direction before cutting it in vertical cross directions to obtain smaller pieces. The above-mentioned cutting assistant tool can be used for this occasion.

The assistant cutting tool according to the invention further comprises a plate member for mounting an object to be cut which is able to be coupled to the opening portion of said inner space of the body of the tool.

According to the assistant cutting tool, no special cutting board is necessary, because the object is cut on the mounting board; further it is quite convenient to rotate the object when cutting the object in a direction different from the first direction. It is desired that the level of the top surface of the plate member becomes at the same or upper level to that of the end portions of said guiding slits. According to this construction, it can be prevented that the lower end of the object is not cut out.

The assistant cutting tool according to the invention has still another aspect that said tool comprises a means for securing the body and the plate member together. By securing the body and the plate, the operability of the tool is improved. Many means for fixing the body and the plate can be considered. For instance, concave portions and protrusions as stated below, pin and pinholes.

In the preferred embodiments, the inner space has a semi-spherical shape and said plate member has a disk-like shape; said securing member comprises at least one concave portion provided within either one of the opening end portion of the inner space or the surrounding portion of said plate member, and at least one protrusion, that is connectable to said concave portion, should be provided within the other.

Further, it is preferred that two ore more concave portions are provided as the securing member and at least two of the portions are formed with an angle of 90 degrees.

In this manner, by providing convex portions and protrusions, the body and the plate member can be secured together with a simple construction. Further, by arranging at least two concave portions with an angle of 90 degrees, it becomes possible to rotate the object to be cut by 90 degrees very easily. It may be possible to provide three or more concave portions and arrange them at an angle other than 90 degrees so as to cut the object into smaller pieces.

It is further preferred that the plate member comprises grooves that correspond to the slits provided in a vertical direction.

According to this construction, the object can be perfectly cut without leaving a non-cut portion. In addition, since the knife is perfectly guided, the object can be cut out into small pieces even if the knife is blunt.

The assistant cutting tool according to the invention may have a handle, with which the operator can hold the assistant cutting tool very stably, and thus the operability is improved.

The members between the slits provided within the body may comprise beveled edges, which are tapered to outward. According to the tapered portion, the knife is more easily guided into the slits, and then the operability is further improved.

It is preferred that the assistant cutting tool according to the invention has a transparent, semi-transparent or transparent colored body. By making the body transparent, the operator can cut the object while checking the condition thereof inside the body.

### BRIEF DESCRIPTION OF THE DRAWINGS

FIGS. 1(a) to 1(c) are schematic views showing a construction of the first embodiment according to the present invention;

FIG. 2 is a schematic view depicting a construction of the second embodiment according to the present invention;

FIG. 3 is a schematic view depicting a construction of the third embodiment according to the present invention;

FIG. 4 is a schematic view depicting a construction of the fourth embodiment according to the present invention;

FIGS. 5(a) to 5(c) are schematic views depicting a construction of the fifth embodiment according to the present invention;

FIG. 6 is a schematic view depicting a construction of the sixth embodiment according to the present invention; and

FIG. 7 is a schematic view depicting a construction of the seventh embodiment according to the present invention.

### DETAILED EXPLANATION OF THE PREFERRED EMBODIMENTS

The detail of the preferred embodiments of the present invention will be explained below, referring to the attached drawings.

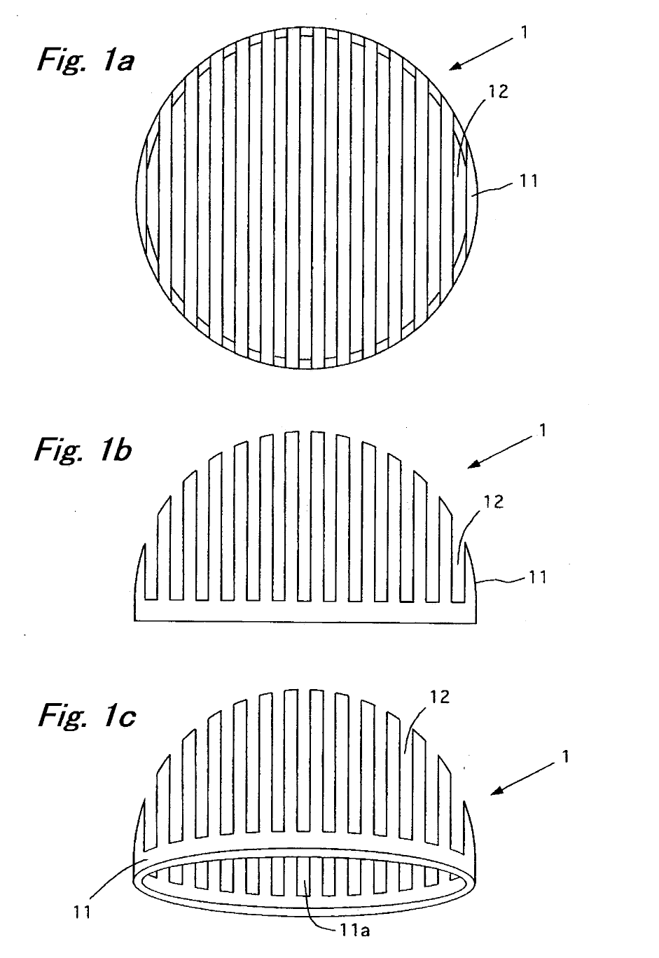

FIG. 1(a) is a plan view showing a construction of the first embodiment of the onion assistant cutting tool according to the present invention. FIG. 1(b) is a front view of the tool and FIG. 1(c) is a perspective viewed from an upper direction.

The assistant cutting tool 1 of the first embodiment is so designed for cutting vegetables having a spherical shape, such as onions. The tool 1 comprises a covering body 11 having a semi-spherical inner space 11a and a plurality of slits 12 for guiding a knife. The slits are provided all over the body 11 being traversed the body 11 so as to connect the inner space 11a and the outer space. The circumference surface of the opening end of the inner space 11a is arranged to be flat. The slits 12 are extended to the portion in the vicinity of the opening end of the inner space in a direction perpendicular with respect to the circumference surface of the inner space 11a with the same distance. The body 11 is made of a solid material such as a hard plastic; the members between the slits 12 are united at the circumference portion 11b of the inner space 11a.

The body 11 has a thickness of about 2 to 5 mm and a dome-like shape with a diameter of about 8˜12 cm, so that a half cut standard size onion can be held in the dome-like (semi-spherical) inner space 11a. The body 11 is made of a transparent, or half transparent, or transparent colored material, so that the operator can see the inside of the dome.

The slits 12 has a width of about 5 mm and are provided in a direction perpendicular to the circumference 11b of the opening end, so that the blade of knife can be inserted inside the inner space 11a via the slits 12. The slits 12 are provided all over the body 11 with a distance of about 8˜10 mm being parallel to each other. Each slit 12 is extended to the height of about 5 mm above from the circumference surface 11b of the opening portion. The half cut onion held in the inner space 11a is sliced in a perpendicular direction by inserting the knife in the slits 12 successively. After cutting the onion in one direction by inserting the knife into all slits 12, then the body 11 (or the object) can be rotated about 90 degrees and insert the knife through the slits 12 again to cut the onion in another direction to obtain small pieces of onion.

The dimension of the body 11, the width of the slits 12, the distance between the abutted slits 12 are not limited to the above-mentioned embodiment, but can be altered in accordance with the shape of vegetable to be cut or the type of knife to be used, etc. It may be possible to provide a plurality of assistant cutting tools having different sizes for users.

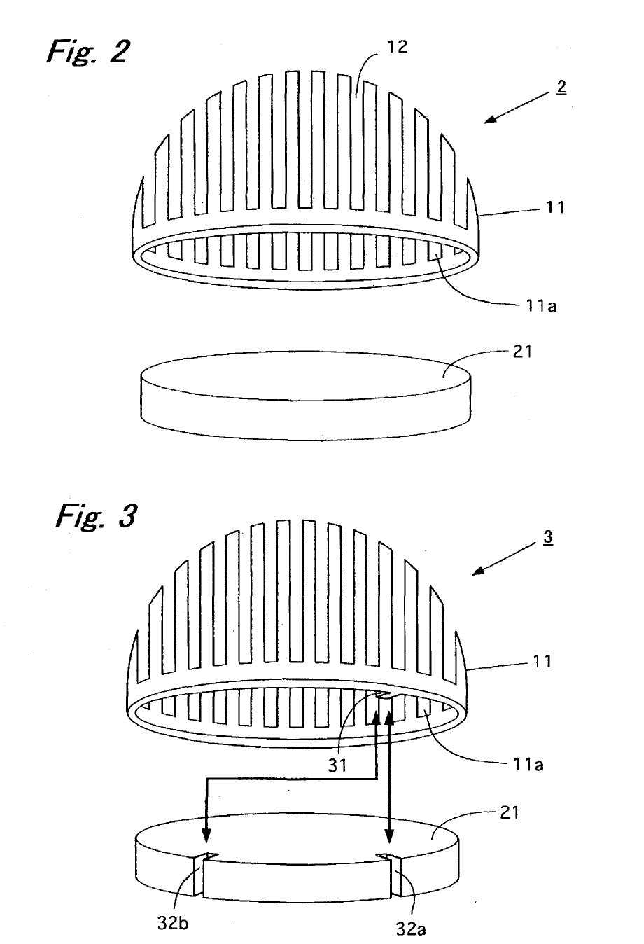

FIG. 2 is a schematic view of the second embodiment according to the present invention. As shown in FIG. 2, the assistant cutting tool 2 of the second embodiment comprises a mounting plate 21 for mounting an object to be cut (onion) in addition to the tool 11 shown in FIG. 1. The mounting plate 21 has a disk-like shape having a diameter that is slightly smaller than that of the opening end portion 11b of the body 11 and a height of about 5 mm. Synthetic resin or wood can be preferably used as a material of the mounting plate 21.

In the second embodiment, a half cut onion is mounted on the board 21 and the body 11 is put on the onion to hold it inside of the inner space 11a, and then cut the onion in a first direction by inserting a knife through the slits 12 successively. Then, the mounting plate 21 is rotated by 90 degrees with the onion and then cut the onion in a second direction to obtain small pieces of onion. According to the assistant cutting tool 2 of the second embodiment, it is not necessary to use a big cutting board and the operation for rotating onion becomes easier. Further, the problem can be solved that the cutout onion is left piece by piece.

As shown in FIG. 2, it is preferred that the mounting plate 21 has a height of more than 5 mm and the diameter of the plate 21 is smaller than that of the opening portion of the body 11 so that when the mounting plate 21 and the body 11 are coupled together, the upper side surface of the mounting plate 21 comes to the same or upper level of the lower end of the slits 12 in the body 11. By this arrangement, the onion can be cut out without leaving a connected portion. It may be possible to provide a plurality of mounting plate having different size (different diameters, or different diameters and different heights) so that the operator can choose an appropriate size of the plate 21 in accordance with the size of the object to be cut (onion).

The shape of the mounting plate 21 is not limited to the disk shape, however it is preferred that when the plate 21 is coupled to the body 11, the upper surface of the mounting plate 21 comes to the same or upper level of the lower end of the slits 12.

FIG. 3 is a schematic view showing a construction of the third embodiment of the present invention. The assistant cutting tool according to the third embodiment further comprises a securing member for securing the body 11 and the mounting plate 21 together in addition to the construction of the second embodiment. In this embodiment, the fixing member is constituted of a protrusion 31, which is provided in the inner circumference surface of the lower portion of the body 11, and two concave portions 32a and 32b, which are engageable to the protrusion 31, are provided within the outer circumference of the mounting plate 21. The concave portions 32a and 32b are formed with about 90 degrees to each other.

In the third embodiment, the object to be cut (half-cut onion) is mounted on the mounting plate 21 and then the protrusion 31 and one of the concave portions are engaged to secure the body 11 and the mounting plate 21, and then the onion is cut in the first direction by inserting a knife through the slits 12 successively. Then, releasing the engagement of the body 11 and the plate 21, and engaging the protrusion 31 to the other concave portion to secure the body 11 and the mounting plate 21 again and cutting the onion in the second direction inserting the knife through the slits 12 again to obtain small pieces of onion. Since the concave portions 32a and 32b are located with 90 degrees, the object to be cut (onion) is cut out in crossing directions by changing the engagement of the protrusion 31 and the concave portions 32a and 32b.

In the third embodiment, one protrusion (31) is provided on the body 11 side and two concave portions (32a, 32b) on the mounting plate 21 side. However, it is still effective that only one protrusion and one concave portion are provided on the body and plate side, respectively, to secure the body 11 and the plate 21 stable during working.

It should be noted that such an arrangement is also effective to provide a concave portion(s) on the body side and a protrusion(s) on the mounting plate side.

Further, two or more protrusions and one concave portion, or one protrusion and one concave portion, or two or more protrusions and two or more concave portions may be formed. In these cases, it is preferred that at least two of the protrusions or concave portions are formed at 90 degrees to each other. However, the relative angle of the protrusions or concave portions is not limited to 90 degrees but may be other degrees, for instance, 30 or 60 degrees, in order to obtain smaller pieces of the object.

Furthermore, in the third embodiment, the protrusion 31 and the concave portions 32a and 32b are formed as the securing means, however, any type of means may be applied as far as the body 11 and the mounting plate 21 are secured together. For instance, pin and pinholes are preferably used.

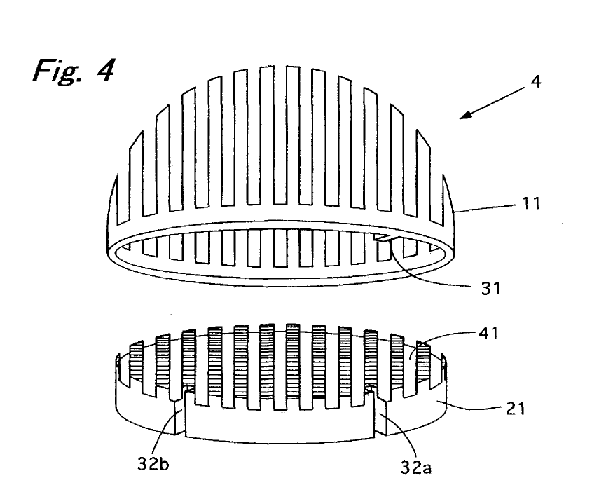

FIG. 4 is a schematic view showing the construction of the fourth embodiment of the present invention. In the fourth embodiment, grooves 41 are provided on the upper surface of the mounting plate 21, which are corresponding to the slits 12 provided in a vertical direction within the body 11, in addition to the construction according to the third embodiment. The positions of the grooves 41 are significantly defined in accordance with the position of the securing means, i.e. the protrusion 31 and the concave portions 32a and 32b. It is preferred that the grooves 41 have a depth of about 1 mm or more.

By the grooves 41 on the mounting plate 21, which are corresponding to the slits 12, it becomes possible to put the blade of knife till the bottom of the grooves 41, so that the object to be cut (onion) can be cut out perfectly. In addition, even if a blunt knife is used, the object can be cut without problem.

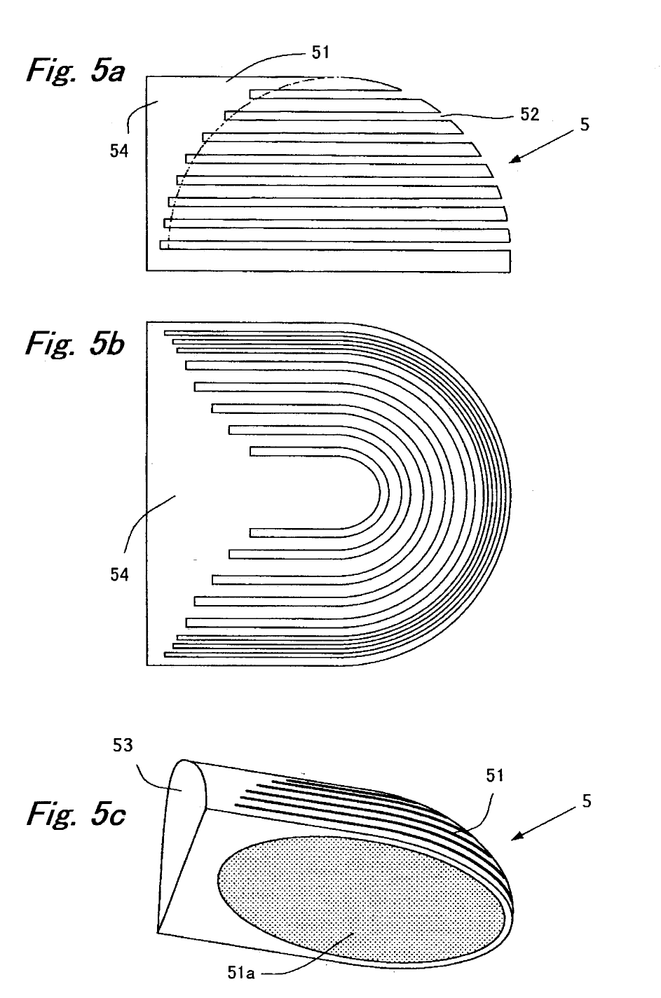

FIGS. 5(a) to (c) are schematic views showing the construction of the assistant cutting tool according to the fifth embodiment of the present invention. FIGS. 5(a) is a side view, (b) is a plan view and (c) is a perspective view viewed from the lower direction. As shown in FIGS. 5(a) to (c), the body 51 has a semi-spherical shaped inner space 51a; a plurality of slits 52 are formed in the body 51 in a direction parallel to the opening end surface 51b of the body 51. The slits 52 are provided all over the body 51 so as to connect the inside of the inner space 51a and the outer space, and extended in the same direction (cutting direction). The slits 52 are extended until the inside surface of the inner space 51a. That is to say, extended until the farthest portion of the inner space 51a from the beginning portion of the slits in the cutting direction. It should be noted that a solid portion 53 is provided on the opposite side to keep the unity of the guide members' 51c between the slits 52, which are extended in the cutting direction in parallel.

The assistant cutting tool shown in FIGS. 5(a) to (c) is used for cutting the object in a horizontal direction before cutting it in a perpendicular direction. Therefore, the assistant cutting tool is used as a set with the tool of the first to fourth embodiments explained above. It is desired that the assistant cutting tool 5 of the fifth embodiment is used with a mounting plate 21 as shown in FIGS. 2 to 4. After the object is cut in a horizontal direction with the aid of assistant cutting tool 5, and then change the tool (body) having the slits in a vertical direction (shown in FIGS. 1 to 4) to cut the object in vertical directions. A good skill is normally required to cut vegetables having a spherical shape in a horizontal direction, such as onions; however, it becomes easy to cut them by using the assistant cutting tool 5 of the fifth embodiment.

In the above-mentioned embodiment, the slits 52 are extended to the position beyond the inside surface of the inner space 51a opposite to the beginning position of cutting slits, so that the object is wholly cut out in a horizontal direction. However, it may be arranged such that the slits 52 are extended not beyond but just before the inside surface of the inner space 51, which is opposite to the beginning point of the slits 52 so as to leave an uncut portion of the object. It can be prevented thereby that the object is left piece by piece before cutting it in a vertical direction. It may be possible to use a stopper member (not shown) having the engageable shape to the outer shape of the body 51 to prevent that the blade of knife reaches to the end of the slits 52.

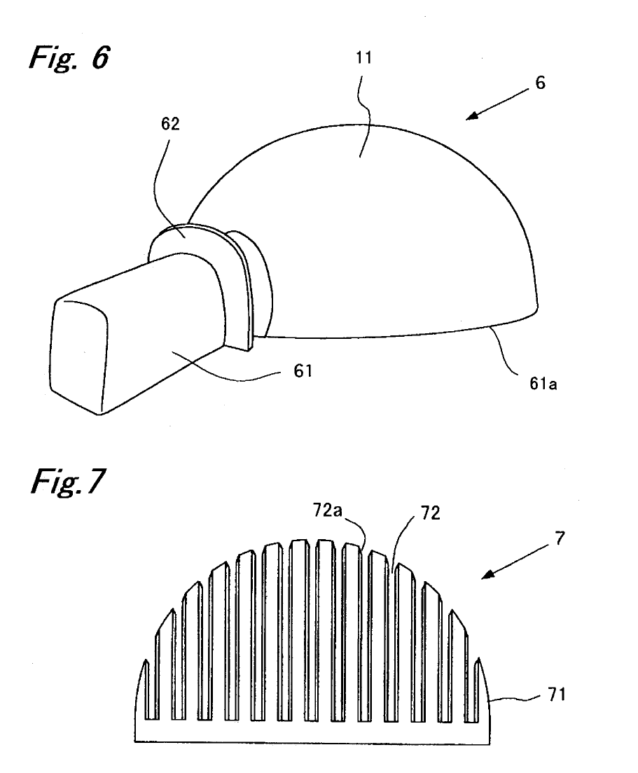

FIG. 6 is a schematic view showing a construction of the sixth embodiment according to the present invention. In the sixth embodiment, a handle 61 is provided to the body 11 (or 21˜51 in FIGS. 2 to 5) as a united body. It should be noted that the slits provided within the body 61 are not shown. As shown in FIG. 6, the handle 62 is formed such that the lower end portion of the handle 62 is positioned on the same level of the opening end surface of the inner space 61a. It may be possible to provide a flange between the handle 63 and the body 61 that is protruded outwardly about 8 to 10 cm. In case that the handle is given to the assistant cutting tool shown in FIG. 5, it is preferred to provide the handle to the solid portion 53.

The handle to each assistant cutting tool shown in FIGS. 1 to 5 improves the operability. That is to say, the operator does not necessary to hold the body itself, therefore, the inconvenience, particularly in the tool having a semi-spherical outer shape as shown in FIGS. 1 to 4, can be solved that when cutting the object the smaller portion held by the operator becomes unstable to hold. Further, it is also prevented that the operator's finger is injured, so that the operator can cut the object safely. The length or thickness of the handle 62 may be modified as occasion demands. Further, the construction of the flange 63 is not limited to that shown in FIG. 6. For instance, the flange 63 may be comparatively large and inclined or bent toward the operator side in order to protect the operator's fingers.

FIG. 7 is a schematic view showing a construction of the assistant cutting tool 7 according to the seventh embodiment of the present invention. In the seventh embodiment, each of the members between the slits 72 of the body 71 has a tapered portion 72a, which is tapered toward the outside. According to the tapered construction, the knife is smoothly guided and thus the operability is improved. In FIG. 7, the assistant cutting tool shown in FIG. 1 is modified so that the members have a tapered portion. However, the other tools shown in FIGS. 2 to 6 may also have a tapered portion in the same manner.

The assistant cutting tools 1 to 7 explained above or the alternatives thereof can be manufactured easily and cheaply, for example, by injecting a synthetic resin. The technical scope of the invention is not limited to the above-mentioned embodiments, but may include many alternatives or modifications so far as they contain the technical characters in the attached claims. In the above embodiments, onion is explained as an object to be cut, but the invention can be applied to cut other vegetables such as carrots, radishes, etc. into small pieces. In these cases, the shape of the inner space should be modified so as to meet the outer shape of the vegetables to be cut.

As explained, according to the invention, the object is cut out under the condition that the object is covered with a tool having an inner space having the same shape of the outer shape of the object to be cut; therefore, the object is not left piece by piece, and then the object can be cut easily. Further, since the slits in the body are extended straight and parallel to each other, the object can be cut into the same size pieces by inserting the knife through the slits. Furthermore, since each slit is independently formed, the knife is guided certainly into the inner space; therefore, the object can be cut into the same size pieces easily and quickly.

What is claimed is:

1. An assistant cutting tool comprising an inner space being capable to hold an object to be cut there inside and having an opening, and a plurality of slits for guiding a knife connecting said inner space and an outside of the tool, wherein an end surface of said opening is flat.

2. An assistant cutting tool according to claim 1, wherein said slits are provided in a direction perpendicular to said end surface of opening and parallel to each other.

3. An assistant cutting tool according to claim 2, distances between said slits has the same width.

4. An assistant cutting tool according to claim 3, wherein said inner space has a semi-spherical shape and each of said slits is extended to a portion in the vicinity of said end surface of opening.

5. An assistant cutting tool according to claim 1, wherein said inner space has a semi-spherical shape and each of said slits are provided to be parallel to said end surface of opening and in the same direction from one side, and said slits are extended to a portion in the vicinity of a surface of said inner space on the other side, which is opposite to said one side.

6. An assistant cutting tool according to claim 1 further comprising a plate member for mounting an object to be cut being engageable to said opening of inner space.

7. An assistant cutting tool according to claim 6, wherein said tool further comprises a means for securing said body and said plate member.

8. An assistant cutting tool according to claim 7, wherein said inner space of the body has a semi-spherical surface and said plate member has a disk-like shape; said securing means comprises at least one convex portion being provided either within a circumference of said opening of the inner space or within a circumference of said plate member, and at least protrusion being capable to be engaged to said concave portion being provided either on a circumference of said opening of the inner space or on a circumfuse of said plate member so as to be opposite to said concave portion.

9. An assistant cutting tool according to claim 8, wherein two or more concave portions are provided and wherein at least two of these concave portions are formed at 90 degrees to each other.

10. An assistant cutting tool according to claim 6, wherein said plate member comprises a plurality of grooves on a surface thereof so as to correspond to said first slits.

11. An assistant cutting tool according to claim 1 further comprising a handle.

12. An assistant cutting tool according to claim 1, wherein said members between said first slits comprise a tapered portion, respectively.

13. An assistant cutting tool according to claim 5, wherein members between said second slits comprise a tapered portion, respectively.

14. An assistant cutting tool according to claim 1, wherein said body is transparent, or semi-transparent, or transparent colored.
